(19) United States
(12) Patent Application Publication
(10) Pub. No.: US 2024/0280131 A1
(43) Pub. Date: Aug. 22, 2024

(54) Pre-Assembly Member and Pre-Assembled Nut Assembly Comprising Same

(71) Applicant: Illinois Tool Works Inc., Glenview, IL (US)

(72) Inventors: Zheng LUO, Shanghai (CN); Zhilin LI, Shanghai (CN); Haijie YU, Shanghai (CN)

(21) Appl. No.: 18/439,167

(22) Filed: Feb. 12, 2024

(30) Foreign Application Priority Data
Feb. 16, 2023 (CN) 2023101732237
Feb. 2, 2024 (CN) 2024101529317

(51) Int. Cl. F16B 37/04; B60N 2/015

(52) U.S. Cl. CPC F16B 37/044; B60N 2/015

(57) ABSTRACT

The present disclosure relates to the technical field of vehicle components, and in particular, to a pre-assembly member for securing a vehicle nut to a U-shaped structural member. The pre-assembly member includes: a base portion; and a clamping portion. The clamping portion is formed by bending and extending upward from a rear portion of the base portion, and the clamping portion is configured to secure the pre-assembly member to the U-shaped structural member. The pre-assembly member provided by the present disclosure can easily mount the vehicle nut firmly in the U-shaped structural member, and prevent the nut from rotating in the process of mounting a bolt to the nut, so that the bolt is more convenient to mount.

### RELATED APPLICATIONS

The present application claims the benefit of Chinese Patent Application Nos. CN 2023101732237, filed Feb. 16, 2023, and CN 2024101529317, filed Feb. 2, 2024, each titled “Pre-Assembly Member and Pre-Assembled Nut Assembly Comprising Same,” the contents of which are hereby incorporated by reference.

### TECHNICAL FIELD

The present disclosure relates to the technical field of vehicle components, and in particular, to a pre-assembly member for mounting a vehicle nut to a U-shaped structural member.

### BACKGROUND

There is a U-shaped structural member in a vehicle for securing a vehicle seat. A nut is pre-assembled on the U-shaped structural member. The vehicle seat is secured to the nut of the U-shaped structural member by means of a bolt, and accordingly the vehicle seat is secured to the U-shaped structural member. Therefore, there is a need for a pre-assembly member capable of easily and firmly pre-assembling a nut to a U-shaped structural member.

### SUMMARY OF THE DISCLOSURE

The present disclosure relates generally to a U-shaped structural member, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a schematic diagram of a U-shaped structural member 100 with a pre-assembled nut assembly of the present disclosure.

FIG. 2A is a perspective schematic diagram of a pre-assembly member 200 according to an embodiment of the present disclosure.

FIG. 2B is a perspective schematic diagram of the pre-assembly member 200 shown in FIG. 2A, which is overturned by 180 degrees.

FIG. 3A is a perspective schematic diagram of a pre-assembly member 300 according to another embodiment of the present disclosure.

FIG. 3B is a perspective schematic diagram of the pre-assembly member 300 shown in FIG. 3A, which is overturned by 180 degrees.

FIG. 4A is a perspective schematic diagram of a nut 400 shown in FIG. 1.

FIG. 4B is a perspective schematic diagram of the nut 400 shown in FIG. 4A, which is overturned by 180 degrees.

FIG. 5 is a perspective schematic diagram of a pre-assembled nut assembly formed by the pre-assembly member 200 shown in FIG. 2A and the nut 400 shown in FIG. 4A.

FIG. 6 is a perspective schematic diagram of a pre-assembled nut assembly formed by the pre-assembly member 300 shown in FIG. 3A and the nut 400 shown in FIG. 4A.

### DETAILED DESCRIPTION OF EMBODIMENTS

Various specific implementations of the present disclosure will be described below with reference to the accompanying drawings which constitute part of the present disclosure, but would not limit the scope of the present disclosure. It should be understood that although the terms such as “front”, “rear”, “upper”, “lower”, “left”, “right” and so on indicating directions are used in the present disclosure to describe orientations of various illustrative structural parts and elements in the present disclosure, the terms used herein are merely used for ease of description and are determined based on the illustrative orientation shown in the accompanying drawings. Since the embodiments disclosed in the present disclosure can be provided in different orientations, the terms indicating directions are merely illustrative and should not be considered as limitations. In addition, the terms “first”, “second”, etc. used in the present disclosure are merely used to distinguish different objects, instead of indicating that there is any particular sequential relationship between these objects. The term “comprise/include” and derivatives thereof mean inclusion without limitation. Unless otherwise specified and limited, the terms “mounting”, “connecting” and “connection” should be understood broadly. For example, they may be mechanical or electrical connection, internal communication between two elements, or direct connection or indirect connection via an intermediate medium. For those of ordinary skills in the art, the specific meanings of the above terms can be understood according to specific cases. If possible, the same or similar reference numerals used in the present disclosure refer to the same components.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

At present, a nut is pre-secured to a U-shaped structural member by means of welding. However, since the U-shaped structural members used for some vehicle models are made of aluminum, it is impossible to secure the nuts to the U-shaped structural members by means of welding. In this case, the nuts are secured to the aluminum U-shaped structural members generally by means of pull riveting. However, the pull riveting method has a higher holing precision requirement on corresponding holes in the U-shaped structural members. If the holes are too large, the nuts may be pulled out through the holes in a pull riveting process. In addition, a special pull riveting tool is required to mount the nuts into the holes of the U-shaped structural members, which brings inconvenience to the nut mounting.

Therefore, there is a need for a pre-assembly member for pre-mounting a nut to a U-shaped structural member. When the U-shaped structural member is an aluminum member, the pre-assembly member can pre-mount the nut to the aluminum U-shaped structural member in a simple manner, and prevent the nut from rotating in the subsequent process of securing a vehicle seat to the nut in the U-shaped structural member by means of a bolt, so that the bolt mounting is more convenient.

According to a first aspect of the present disclosure, a pre-assembly member for mounting to a U-shaped structural member is provided. The pre-assembly member is characterized by comprising: a base portion and a clamping portion, wherein the clamping portion is formed by bending and extending upward from a rear portion of the base portion, and the clamping portion is configured to secure the pre-assembly member to the U-shaped structural member.

According to the first aspect of the present disclosure, the pre-assembly member is characterized in that the base portion comprises: a hole, the hole being formed in the base portion; a front bending edge, the front bending edge extending upward from a front portion of the base portion, and the front bending edge forming a front blocking portion; two side bending edges, the two side bending edges being provided opposite each other, the two side bending edges respectively extending upward from two side portions of the base portion, and the two side bending edges forming two side blocking portions; and two transverse bending edges, the two transverse bending edges respectively extending from distal ends of the two side bending edges, and two side mounting spaces being formed below the two side bending edges.

According to the first aspect of the present disclosure, the pre-assembly member is characterized in that the base portion extends downward from a lower surface thereof to form an extension portion, and the extension portion has different heights in a direction from the front portion to the rear portion of the base portion and is configured to clamp the pre-assembly member in the U-shaped structural member.

According to the first aspect of the present disclosure, the pre-assembly member is characterized in that the extension portion is an inclined cut portion formed by extending downward from the base portion along the hole diameter of the hole.

According to the first aspect of the present disclosure, the pre-assembly member is characterized in that the extension portion is a cantilever portion formed by extending downward from the base portion along an edge of the hole, the cantilever portion is of an annular structure, and part of an edge of the annular structure is connected to the base portion.

According to the first aspect of the present disclosure, the pre-assembly member is characterized in that a clamping tail is provided at a distal end of the clamping portion.

According to the first aspect of the present disclosure, the pre-assembly member is characterized in that the clamping tail is made of an elastic material.

According to the first aspect of the present disclosure, the pre-assembly member is characterized in that the clamping tail comprises one or more clamping tail portions.

According to the first aspect of the present disclosure, the pre-assembly member is characterized in that a tongue is provided at a proximal end of the clamping portion, the tongue is arranged between the two side bending edges, and a rear mounting space is formed below the tongue.

According to the first aspect of the present disclosure, the pre-assembly member is characterized in that the tongue extends from the proximal end of the clamping portion toward the base portion.

According to the first aspect of the present disclosure, the pre-assembly member is characterized in that reinforcing ribs are provided in a middle portion of the clamping portion between the distal end and the proximal end, and the reinforcing ribs protrude from the middle portion of the clamping portion in a direction away from or close to the base portion.

According to the first aspect of the present disclosure, the pre-assembly member is characterized in that a plurality of elastic sheet portions are provided on the base portion, with one end of each elastic sheet portion being connected to the base portion, and the other end thereof protruding from an upper surface of the base portion.

According to the first aspect of the present disclosure, the pre-assembly member is characterized in that the pre-assembly member is integrally formed.

According to the first aspect of the present disclosure, the pre-assembly member is characterized in that the clamping portion is configured to be in shape fit with the U-shaped structural member, such that the clamping portion secures the pre-assembly member to the U-shaped structural member.

According to another aspect of the present disclosure, a pre-assembled nut assembly is provided. The pre-assembled nut assembly is characterized by comprising: a pre-assembly member and a nut, wherein the nut is configured to be mounted in the base portion of the pre-assembly member.

According to another aspect of the present disclosure, the pre-assembled nut assembly is characterized in that the nut comprises: a base and a body. A middle portion of the base is provided with a nut hole, and the base has a front portion, a rear portion and two side portions. The body extends around the nut hole of the base to form a cylindrical section, and the cylindrical section is in hollow communication with the nut hole.

According to another aspect of the present disclosure, the pre-assembled nut assembly is characterized in that an inner wall of the cylindrical section is provided with internal threads.

According to another aspect of the present disclosure, the pre-assembled nut assembly is characterized in that two ends of the front portion of the base of the nut respectively extend to form two front end corners; and two ends of the rear portion of the base of the nut respectively extend to form two rear end corners; wherein the two front end corners and the two rear end corners are slightly upturned.

According to another aspect of the present disclosure, the pre-assembled nut assembly is characterized in that when the base of the nut is mounted in the base portion of the pre-assembly member, the two front end corners and the two rear end corners protrude from the base portion.

According to another aspect of the present disclosure, the pre-assembled nut assembly is characterized in that when the nut is mounted in the base portion of the pre-assembly member, the nut hole of the nut is aligned to and in communication with the hole of the pre-assembly member.

According to another aspect of the present disclosure, the pre-assembled nut assembly is characterized in that when the nut is mounted in the base portion of the pre-assembly member, the two side portions of the base of the nut are respectively accommodated in the two side mounting spaces formed below the two side bending edges of the pre-assembly member.

According to another aspect of the present disclosure, the pre-assembled nut assembly is characterized in that when the base of the nut is mounted in the base portion of the pre-assembly member, the front bending edge of the pre-assembly member blocks one of the front portion and the rear portion of the base of the nut, and the tongue of the pre-assembly member blocks the other of the front portion and the rear portion of the base of the nut.

According to another aspect of the present disclosure, the pre-assembled nut assembly is characterized in that when the base of the nut is mounted in the base portion of the pre-assembly member, the base of the nut abuts against the plurality of elastic sheet portions on the base portion.

According to still another aspect of the present disclosure, a U-shaped structural member with a pre-assembled nut assembly is provided. The U-shaped structural member is characterized by comprising: the pre-assembled nut assembly and a U-shaped structural member; wherein the pre-assembled nut assembly is configured to be securely mounted in the U-shaped structural member.

Some of the additional aspects and advantages of the present disclosure will be set forth in the following description, and some will become apparent from the following description, or be learned by practice of the present disclosure.

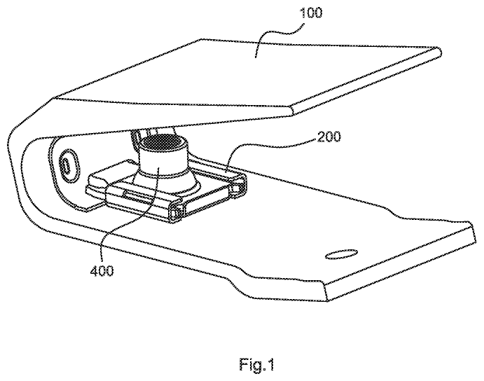

FIG. 1 is a schematic diagram of a U-shaped structural member 100 with a pre-assembled nut assembly of the present disclosure.

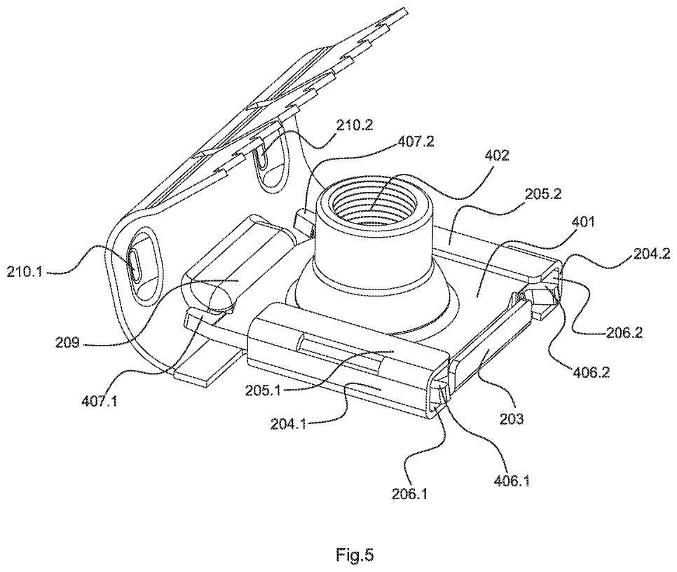

As shown in FIG. 1, a nut 400 is mounted in a pre-assembly member 200 to form a pre-assembled nut assembly (as shown in FIG. 5), and the pre-assembled nut assembly is then mounted to a U-shaped structural member 100, thereby forming the U-shaped structural member with the pre-assembled nut assembly.

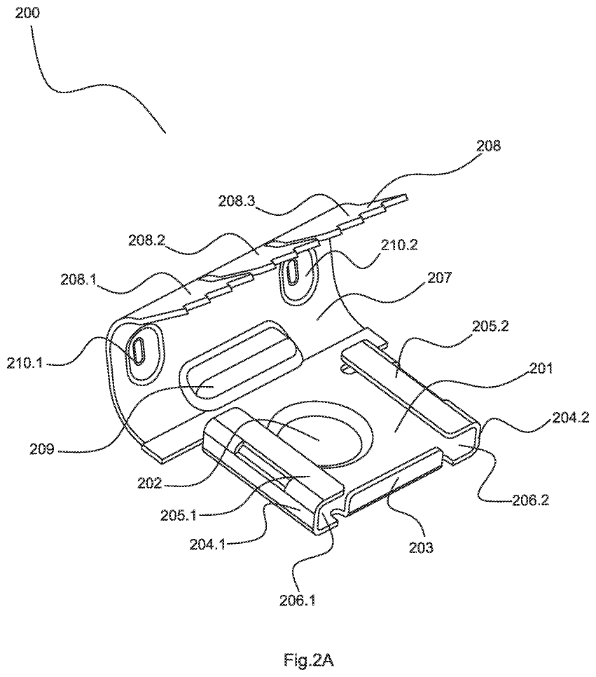

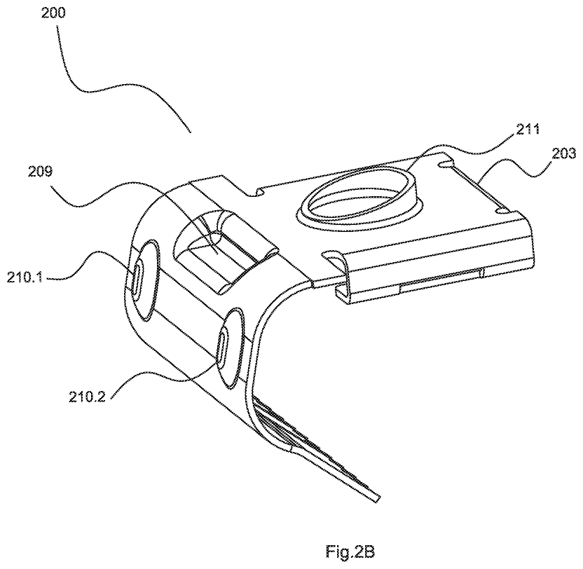

FIG. 2A is a perspective schematic diagram of a pre-assembly member 200 according to an embodiment of the present disclosure.

As shown in FIG. 2A, the pre-assembly member 200 comprises a base portion 201 and a clamping portion 207. A hole 202 is formed in a middle portion of the base portion 201. When the nut 102 is mounted in the base portion 201, the hole 202 is substantially aligned to a screw hole of the nut 400, thereby allowing a bolt to pass through the hole 202 and the screw hole of the nut for mounting. The base portion 201 further has a front bending edge 203, two side bending edges 204.1, 204.2, and two transverse bending edges 205.1, 205.2. The front bending edge 203 extends upward from a front portion of the base portion 201 to form a front blocking portion, and the two side bending edges 204.1, 204.2 respectively extend upward from two side portions of the base portion 201 to form two side blocking portions and further extend transversely to form the two transverse bending edges 205.1, 205.2, such that a side mounting space 206.1 is formed between the side bending edge 204.1 and the transverse bending edge 205.1, and another side mounting space 206.2 is formed between the side bending edge 204.2 and the transverse bending edge 205.2. The two side mounting spaces 206.1, 206.2 are configured to accommodate two side portions of the nut when the nut 400 is mounted in the base portion 201.

As shown in FIG. 2A, the clamping portion 207 is formed by bending and extending upward from a rear portion of the base portion 201. A tongue 209 is provided at a front end of the clamping portion 207 close to the base portion 201, and the tongue 209 is arranged between the two side bending edges 204.1, 204.2 of the base portion 201 and extends from a surface of the clamping portion 207 toward the base portion 201 to form a projection. A rear mounting space is formed below the tongue 209 and is configured to accommodate a rear portion of the nut 400 when the nut 400 is mounted in the base portion 201. It is understood by those skilled in the art that the tongue 209 may be formed in any other shape other than the projection. A clamping tail 208 is provided at a distal end of the clamping portion 207 away from the base portion 201, and the clamping tail 208 is made of an elastic material and has saw teeth formed at an end portion thereof. When the pre-assembly member 200 is mounted in the U-shaped structural member 100, the saw teeth of the clamping tail 208 abut against an internal upper surface of the U-shaped structural member 100, such that the pre-assembly member 200 is firmly fixed in the U-shaped structural member 100 by means of a friction force between the saw teeth and the internal upper surface of the U-shaped structural member 100. As shown in FIG. 2A, in an embodiment, the clamping tail 208 is divided into three clamping tail portions 208.1, 208.2, 208.3, such that when the internal upper surface of the U-shaped structural member 100 is uneven, the three clamping tail portions 208.1, 208.2, 208.3 can each better fit different portions of the internal upper surface of the U-shaped structural member 100, thereby increasing the friction force between the clamping tail 208 and the internal upper surface of the U-shaped structural member 100. It is understood by those skilled in the art that the clamping tail 208 may also be formed into a whole, or divided into a plurality of clamping tail portions, so as to better fit the internal upper surface of the U-shaped structural member 100.

As shown in FIG. 2A, two reinforcing ribs 210.1, 210.2 are provided in a middle portion of the clamping portion 207 between a proximal end and a distal end. The two reinforcing ribs 210.1, 210.2 extend from the middle portion of the clamping portion 207 in a direction away from the base portion 201 to form two protrusions, and the two protrusions are each provided close to an edge of the clamping portion 207. Returning to FIG. 1, when the pre-assembly member 200 is mounted in the U-shaped structural member 100, the two reinforcing ribs 210.1, 201.2 each abut against an inner surface of a U-shaped portion of the U-shaped structural member 100 to prevent the pre-assembly member 200 and the nut 400 mounted therein from rotating in the process of mounting the bolt to the nut 400 in the pre-assembly member 200, thus facilitating the mounting of the bolt. As shown in FIG. 1, the clamping portion 207 is configured to be in shape fit with the U-shaped structural member 100, such that the clamping portion 207 secures the pre-assembly member 200 to the U-shaped structural member 100.

FIG. 2B is a perspective schematic diagram of the pre-assembly member 200 shown in FIG. 2A, which is overturned by 180 degrees.

As shown in FIG. 2B, the tongue 209 extends from the surface of the clamping portion 207 toward the base portion 201 to form the projection, and the two reinforcing ribs 210.1, 210.2 extend from the middle portion of the clamping portion 207 in the direction away from the base portion 201 to form the two protrusions, the two protrusions being each provided close to the edge of the clamping portion 207. The base portion 201 extends downward from a lower surface thereof to form an extension portion 211. As shown in FIG. 2B, the extension portion 211 is an inclined cut portion 211 formed by the hole 202 in the middle portion of the base portion 201 extending downward from the base portion 201 (relative to the position in FIG. 2A) along the hole diameter thereof, and has a height gradually decreasing in a direction from the front portion to the rear portion of the base portion 201. That is to say, the inclined cut portion 211 extends by a certain height at a position close to the front portion of the base portion 201, and then the height of the inclined cut portion 211 gradually decreases in a direction from the front portion to the rear portion of the base portion 201 until at a position closest to the rear portion of the base portion 201, where the height of the inclined cut portion 211 is kept substantially consistent with a bottom surface of the base portion 201. A peripheral edge of the inclined cut portion 211 is on a plane, and an inclination angle is formed between the plane and the bottom surface of the base portion 201.

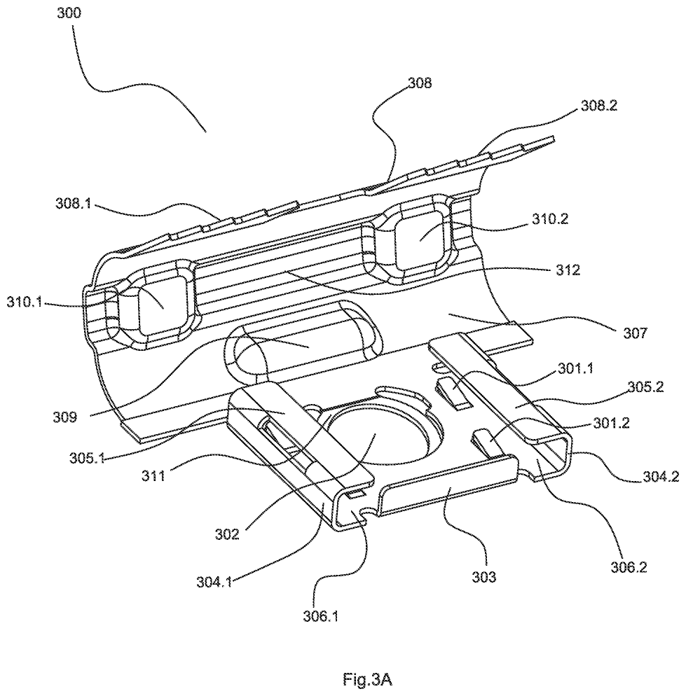

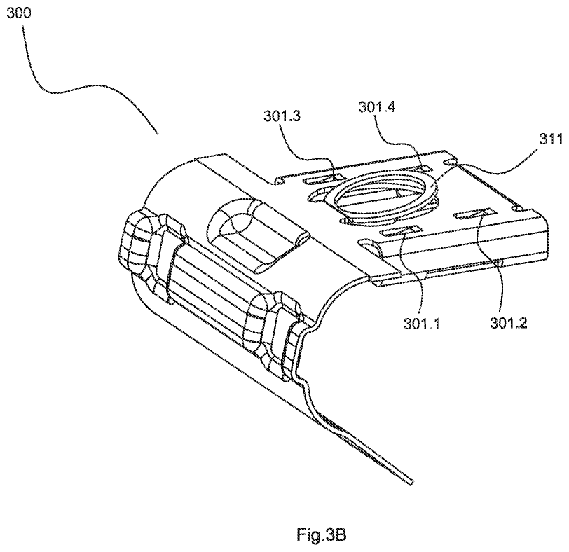

FIG. 3A is a perspective schematic diagram of a pre-assembly member 300 according to another embodiment of the present disclosure.

As shown in FIG. 3A, the pre-assembly member 300 comprises a base portion 301 and a clamping portion 307. A hole 302 is formed in a middle portion of the base portion 301. When the nut 400 is mounted in the base portion 301, the hole 302 is substantially aligned to a screw hole of the nut 400, thereby allowing a bolt to pass through the hole 302 and the screw hole of the nut for mounting. The base portion 301 further has a front bending edge 303, two side bending edges 304.1, 304.2, and two transverse bending edges 305.1, 305.2. The front bending edge 303 extends upward from a front portion of the base portion 301 to form a front blocking portion, and the two side bending edges 304.1, 304.2 respectively extend upward from two side portions of the base portion 301 to form two side blocking portions and further extend transversely to form the two transverse bending edges 305.1, 305.2, such that a side mounting space 306.1 is formed between the side bending edge 304.1 and the transverse bending edge 305.1, and another side mounting space 306.2 is formed between the side bending edge 304.2 and the transverse bending edge 305.2. The two side mounting spaces 306.1, 306.2 are configured to accommodate two side portions of the nut when the nut 400 is mounted in the base portion 301.

As shown in FIG. 3A, the clamping portion 307 is formed by bending and extending upward from a rear portion of the base portion 301. A tongue 309 is provided at a front end of the clamping portion 307 close to the base portion 301, and the tongue 309 is arranged between the two side bending edges 304.1, 304.2 of the base portion 301 and extends from a surface of the clamping portion 307 toward the base portion 301 to form a projection. A rear mounting space is formed below the tongue 309 and is configured to accommodate the rear portion of the nut 400 when the nut 400 is mounted in the base portion 301. It is understood by those skilled in the art that the tongue 309 may be formed in any other shape other than the projection. A clamping tail 308 is provided at a distal end of the clamping portion 307 away from the base portion 301, and the clamping tail 308 is made of an elastic material and has saw teeth formed at an end portion thereof. When the pre-assembly member 300 is mounted in the U-shaped structural member 100, the saw teeth of the clamping tail 308 abut against the internal upper surface of the U-shaped structural member 100, such that the pre-assembly member 300 is firmly fixed in the U-shaped structural member 100 by means of the friction force between the saw teeth and the internal upper surface of the U-shaped structural member 100. As shown in FIG. 3A, in an embodiment, the clamping tail 308 is divided into two clamping tail portions 308.1, 308.2, and the two clamping tail portions 308.1, 308.2 are provided separate from each other with a gap reserved therebetween, such that when the internal upper surface of the U-shaped structural member 100 is uneven, the two clamping tail portions 308.1, 308.2 can each better fit different portions of the internal upper surface of the U-shaped structural member 100, thereby increasing a friction force between the clamping tail 308 and the internal upper surface of the U-shaped structural member 100. Moreover, compared with the three clamping tails shown in FIG. 2A, the two clamping tail structures in FIG. 3A have better deformation capability and can better fit the internal upper surface of the U-shaped structural member 100.

As shown in FIG. 3A, a groove portion 312 is provided in a middle portion of the clamping portion 307 between a proximal end and a distal end, and two reinforcing ribs 310.1, 310.2 are provided in the groove portion 312. The two reinforcing ribs 310.1, 310.2 extend from the middle portion of the clamping portion 307 in a direction close to the base portion 301 to form two protrusions, and the two protrusions are each provided close to an edge of the clamping portion 307. When the pre-assembly member 300 is mounted in the U-shaped structural member 100, the groove portion 312 abuts against the inner surface of the U-shaped portion of the U-shaped structural member 100 to prevent the pre-assembly member 300 and the nut 400 mounted therein from rotating in the process of mounting the bolt to the nut 400 in the pre-assembly member 300, thus facilitating the mounting of the bolt. The clamping portion 307 is configured to be in shape fit with the U-shaped structural member 100, such that the clamping portion 307 secures the pre-assembly member 300 to the U-shaped structural member 100.

FIG. 3B is a perspective schematic diagram of the pre-assembly member 300 shown in FIG. 3A, which is overturned by 180 degrees.

As shown in FIG. 3B, the tongue 309 extends from the surface of the clamping portion 307 toward the base portion 301 to form the projection, and the two reinforcing ribs 310.1, 310.2 extend from the middle portion of the clamping portion 307 in the direction close to the base portion 301 to form the two protrusions, the two protrusions being each provided close to the edge of the clamping portion 307. The base portion 301 extends downward from a lower surface thereof to form an extension portion 311. As shown in FIG. 3B, the extension portion 311 is a cantilever portion 311 formed by extending downward from the base portion 301 along an edge of the hole 302, the cantilever portion 311 is of an annular structure, part of an edge of the annular structure is connected to the base portion 301, other portions of the edge of the annular structure protrude from the base portion to form a free end elastically deformable relative to the base portion 301, and an edge of the free end has a height gradually decreasing in a direction from the front portion to the rear portion of the base portion 301. It is understood by those skilled in the art that the extension portion 311 may also be of another structure as long as the structure can achieve required functions.

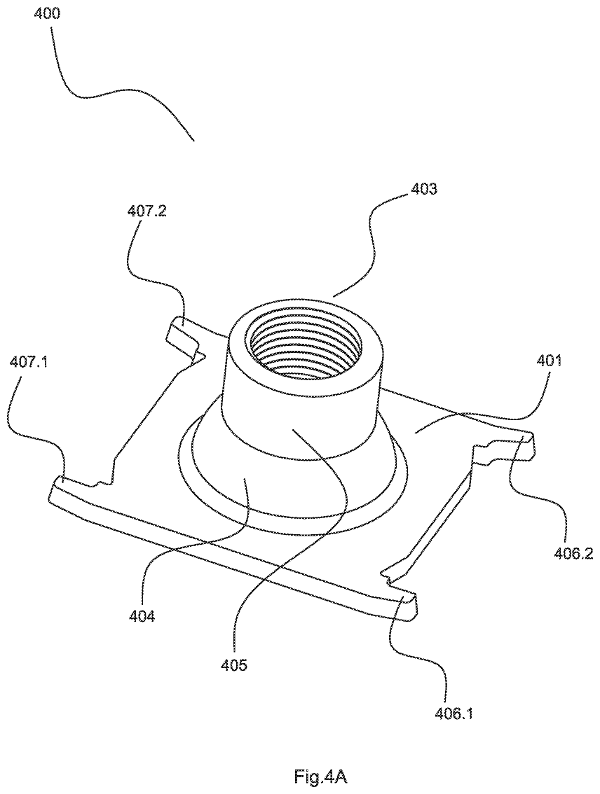

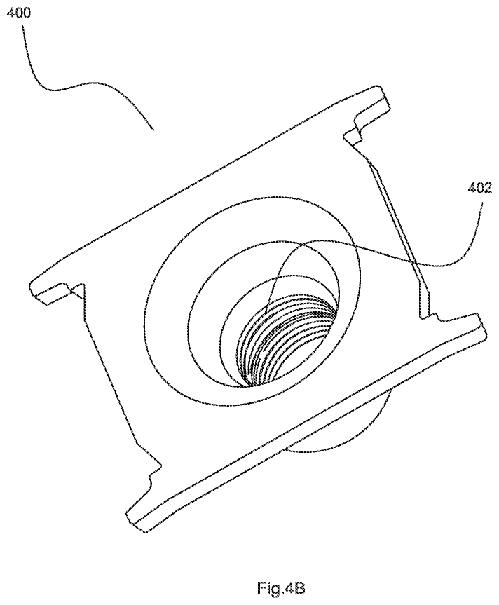

FIG. 4A is a perspective schematic diagram of the nut 400 shown in FIG. 1, and FIG. 4B is a perspective schematic diagram of the nut 400 shown in FIG. 4A, which is overturned by 180 degrees.

As shown in FIGS. 4A and 4B, the nut 400 comprises a base 401 and a body 403. A middle portion of the base 401 is provided with a nut hole 402, and the base 401 has a front portion, a rear portion and two side portions. The body 403 extends around the nut hole 402 of the base 401 to form a conical section 404 and a cylindrical section 405, and an inner wall of the cylindrical section 405 is provided with internal threads and is in hollow communication with the nut hole 402. Two ends of the front portion of the base 401 of the nut 400 respectively extend to form two front end corners 406.1, 406.2. Two ends of the rear portion of the base 401 of the nut 400 respectively extend to form two rear end corners 407.1, 407.2. The two front end corners 406.1, 406.2 and the two rear end corners 407.1, 407.2 are slightly upturned.

FIG. 5 is a perspective schematic diagram of a pre-assembled nut assembly formed by the pre-assembly member 200 shown in FIG. 2A and the nut 400 shown in FIG. 4A.

As shown in FIG. 5, the pre-assembled nut assembly comprises the pre-assembly member 200 as shown in FIGS. 2A and 2B and the nut 400 as shown in FIGS. 4A and 4B. FIG. 5 shows a state in which the nut 400 is mounted in the pre-assembly member 200. As shown in FIG. 5, when the nut 400 is mounted in the pre-assembly member 200, the nut hole 402 of the nut 400 is substantially aligned to the hole 202 of the pre-assembly member 200. As shown in FIG. 1, when the pre-assembled nut assembly is further mounted in the U-shaped structural member 100, the nut hole 402 of the nut 400, the hole 202 of the pre-assembly member 200 and a hole (not shown) formed in the U-shaped structural member 100 are substantially aligned so as to allow subsequent insertion of the bolt. When the base 401 of the nut 400 is mounted in the base portion 201 of the pre-assembly member 200, the two side portions of the base 401 are respectively accommodated in the two side mounting spaces 206.1, 206.2 of the pre-assembly member 200 formed by the two side bending edges 204.1, 204.2 and the two transverse bending edges 205.1, 205.2, and the two front end corners 406.1, 406.2 and the two rear end corners 407.1, 407.2 of the base 401 of the nut protrude from the base portion 201. The front bending edge 203 of the pre-assembly member 200 blocks one of the front portion and the rear portion of the base 401 of the nut 400, and the tongue 209 of the pre-assembly member 200 blocks the other of the front portion and the rear portion of the base 401 of the nut 400. When the nut 400 is mounted in the pre-assembly member 200, the base 401 of the nut 400 is limited in a blocking space formed by the front bending edge 203, the tongue 209, the two side bending edges 204.1, 204.2 and the two transverse bending edges 205.1, 205.2 of the pre-assembly member 200, so that the nut 400 cannot be separated from the pre-assembly member 200.

Meanwhile, as shown in FIG. 5, a gap is reserved between the front portion of the nut 400 and the front bending edge 203 of the pre-assembly member 200, a gap is reserved between the rear portion of the nut 400 and the tongue 209 of the pre-assembly member 200, and gaps are reserved respectively between the two side portions of the nut 400 and the two side bending edges 204.1, 204.2 and the two transverse bending edges 205.1, 205.2 of the pre-assembly member 200. Therefore, when the nut 400 is mounted in the pre-assembly member 200, the base 401 of the nut 400 can appropriately displace in the blocking space formed by the front bending edge 203, the tongue 209, the two side bending edges 204.1, 204.2 and the two transverse bending edges 205.1, 205.2 of the pre-assembly member 200. As shown in FIG. 1, when the pre-assembled nut assembly is further mounted in the U-shaped structural member 100, the nut hole 402 of the nut 400, the hole 202 of the pre-assembly member 200 and a hole (not shown) formed in the U-shaped structural member 100 are substantially aligned so as to allow subsequent insertion of the bolt. However, due to tolerances in the manufacturing process of components, the hole 202 of the pre-assembly member 200 and the hole (not shown) in the U-shaped structural member 100 may have deviations in position and size, causing that the nut hole 402 of the nut 400, the hole 202 of the pre-assembly member 200 and the hole (not shown) in the U-shaped structural member 100 cannot be aligned. However, by appropriately displacing the base 401 of the nut 400 in the blocking space, the tolerances in the manufacturing process are compensated, such that the nut hole 402 of the nut 400, the hole 202 of the pre-assembly member 200 and the hole (not shown) in the U-shaped structural member 100 are substantially aligned to allow the subsequent insertion of the bolt. In addition, since the base 401 of the nut 400 can be appropriately displaced in the blocking space, the requirements on the manufacturing tolerances of the components are reduced, the manufacturing efficiency is thus improved, and the manufacturing costs are also reduced.

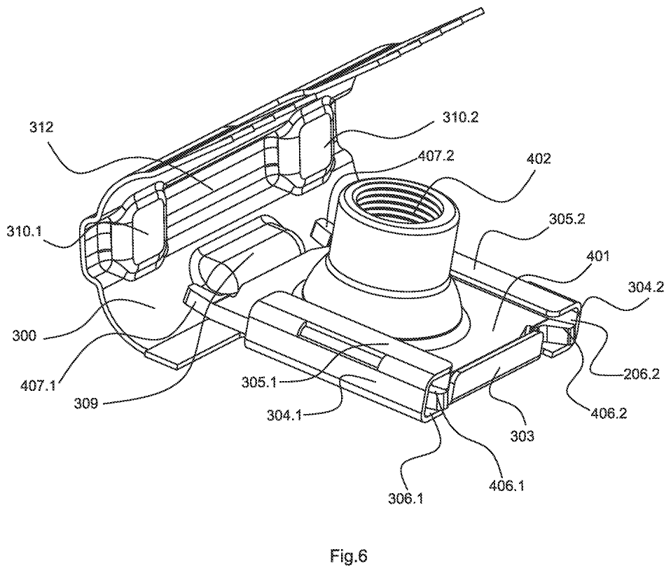

FIG. 6 is a perspective schematic diagram of a pre-assembled nut assembly formed by the pre-assembly member 300 shown in FIG. 3A and the nut 400 shown in FIG. 4A.

As shown in FIG. 6, the pre-assembled nut assembly comprises the pre-assembly member 300 as shown in FIGS. 3A and 3B and the nut 400 as shown in FIGS. 4A and 4B. FIG. 6 shows a state in which the nut 400 is mounted in the pre-assembly member 300. Since the pre-assembly member 300 shown in FIGS. 3A and 3B has a structure substantially similar to the pre-assembly member 200 shown in FIGS. 2A and 2B, when the nut 400 is mounted in the pre-assembly member 300, a structural fit relationship between the pre-assembly member 300 and the nut 400 is similar to a structural fit relationship between the pre-assembly member 200 and the nut 400 illustrated in FIG. 5, which will not be described in detail herein. Their differences lie in that a plurality of elastic sheet portions 301.1, 301.2, 301.3, 301.4 are provided on the base portion 301 of the pre-assembly member 300 shown in FIGS. 3A and 3B, with one end of each elastic sheet portion being connected to the base portion 301, and the other end thereof protruding from an upper surface of the base portion 301 and extending in the direction from the front portion to the rear portion of the base portion 301 (an insertion direction of the nut 400) to form a free end. When the nut 400 is mounted in the pre-assembly member 300, the elastic sheet portions 301.1, 301.2, 301.3, 301.4 abut against the base 401 of the nut 400 to deform, thereby lift the nut 400 up from the base portion 301 of the pre-assembly member 300, so that the bottom surface of the nut 400 does not contact with the upper surface of the base portion 301 of the pre-assembly member 300. By separating the bottom surface of the nut 400 from the upper surface of the base portion 301 of the pre-assembly member 300 with the elastic sheet portions 301.1, 301.2, 301.3, 301.4, the two surfaces can be better coated during surface treatment processes, and the stick-together between the nut 400 and the pre-assembly member 300 can be avoided.

Steps of mounting the nut 400 and the pre-assembly member 200/300 to the U-shaped structural member 100 will be described below with reference to FIGS. 1-6.

In the first step, the pre-assembly member 200/300 is integrally formed by molding. As an embodiment, upon the completion of manufacturing, the base portion 201 and the clamping portion 207 of the pre-assembly member 200 are formed into substantially flat components. In this case, one end of the clamping portion 207 of the pre-assembly member 200 is formed into the clamping tail 208 with a saw-toothed structure as shown in FIG. 2A, and the upwardly protruding tongue 209, the downwardly protruding reinforcing ribs 210.1, 210.2, the downwardly extending inclined extension portion 211 and the hole 202 as shown in FIG. 2A are formed on the base portion 201. As another embodiment, upon the completion of manufacturing, the base portion 301 and the clamping portion 307 of the pre-assembly member 300 are formed into substantially flat components. In this case, one end of the clamping portion 307 of the pre-assembly member 300 is formed into the clamping tail 308 with a saw-toothed structure as shown in FIG. 3A, and the upwardly protruding elastic sheet portions 301.1, 301.2, 301.3, 301.4, the upwardly protruding tongue 309, the upwardly protruding reinforcing ribs 310.1, 310.2, the downwardly extending cantilever portion 311 and the hole 302 as shown in FIG. 3A are formed on the base portion 301;

in the second step, the nut 400 as shown in FIGS. 4A and 4B is placed on the pre-assembly member 200/300 such that the two front end corners 406.1, 406.2 or the two rear end corners 407.1, 407.2 of the nut 400 abut against the two ends of the tongue 209/309 of the pre-assembly member 200/300, and that the nut hole 402 of the nut 400 is substantially aligned to the hole 202/302 of the pre-assembly member 200/300; and

in the third step, the front portion and the two side portions of the base portion 201/301 of the pre-assembly member 200/300 are bent to form the front bending edge 203/303, the two side bending edges 204.1, 204.2/304.1, 304.2 and the two transverse bending edges 205.1, 205.2/305.1, 305.2 as shown in FIGS. 2A, 3A. In this case, the base 401 of the nut 400 is limited in the blocking space formed by the front bending edge 203/303, the tongue 209/309, the two side bending edges 204.1, 204.2/304.1, 304.2 and the two transverse bending edges 205.1, 205.2/305.1, 305.2 of the pre-assembly member 200/300, so that the nut 400 cannot be separated from the pre-assembly member 200/300;

in the fourth step, the clamping portion 207/307 of the pre-assembly member 200/300 is bent to form the pre-assembled nut assembly as shown in FIGS. 5 and 6, so as to be in shape fit with the inner surface of the U-shaped structural member 100. As shown in FIG. 4A, the two front end corners 406.1, 406.2 and the two rear end corners 407.1, 407.2 of the nut 400 are slightly upturned. Therefore, in the process of bending the clamping portion 207/307, the two front end corners 406.1, 406.2 or the two rear end corners 407.1, 407.2 fit the clamping portion in bending radian, so that the end corners of the nut 400 are prevented from interfering with the bending of the clamping portion 207/307; and

in the fifth step, the pre-assembled nut assembly shown in FIGS. 5 and 6 is pushed into an opening of the U-shaped structural member 100 shown in FIG. 1. In an embodiment, in the process of pushing the pre-assembled nut assembly into the U-shaped structural member 100, the peripheral edge of the inclined cut portion 211 of the pre-assembly member 200 is first in contact with the internal lower surface of the U-shaped structural member 100. Due to an inclination angle formed between a peripheral plane of the inclined cut portion 211 and the bottom surface of the base portion 201, the front portion (a portion close to the front bending edge 203) of the pre-assembled nut assembly is lifted by a height from the internal lower surface of the U-shaped structural member 100, and the rear portion (a portion close to the tongue 209) of the pre-assembled nut assembly remains in contact with the internal lower surface of the U-shaped structural member 100. As the pre-assembled nut assembly is further pushed into the U-shaped structural member 100, the clamping tail 208 is in contact with the upper inner surface of the U-shaped structural member 100. In this case, the pre-assembly member 200 is subjected to a pressure from the upper inner surface of the U-shaped structural member 100 by means of the clamping tail 208, and meanwhile is subjected to a pressure from the lower inner surface of the U-shaped structural member 100 by means of the inclined cut portion 211. In this case, as the assembled nut assembly continues to be pushed into the U-shaped structural member 100, the pre-assembly member 200 is further compressed to deform by the upper inner surface and the lower inner surface of the U-shaped structural member 100, and a portion of the inclined cut portion 211 closest to the rear portion of the base portion 201 slides into the hole (not shown) of the U-shaped structural member 100 until the highest extension portion of the inclined cut portion 211 closest to the front portion of the base portion 201 slides into the hole (not shown) of the U-shaped structural member 100. Once the highest extension portion of the inclined cut portion 211 closest to the front portion of the base portion 201 slides into the hole (not shown) of the U-shaped structural member 100, the pre-assembled nut assembly is brought into a mounting position. At this mounting position, the front portion of the base portion 201 of the pre-assembly member 200 rebounds toward the lower inner surface of the U-shaped structural member 100 under the action of a deformation force, such that the lower surface of the base portion 201 completely abuts against the lower inner surface of the U-shaped structural member 100, meanwhile, an outer periphery of the highest extension portion of the inclined cut portion 211 abuts against an inner periphery of the hole (not shown) of the U-shaped structural member 100, and the reinforcing ribs 210.1, 210.2 formed on the clamping portion 207 abut against the inner surface of a bend portion of the U-shaped structural member 100. In this case, the clamping tail 208 of the pre-assembly member 200 abuts against the upper inner surface of the U-shaped structural member 100, the base portion 201 abuts against the lower inner surface of the U-shaped structural member 100, the outer periphery of the highest extension portion of the inclined cut portion 211 abuts against the inner periphery of the hole (not shown) of the U-shaped structural member 100, and the reinforcing ribs 210.1, 210.2 abut against an inner surface of the bend portion of the U-shaped structural member 100, such that a force is applied to the pre-assembly member 200 in up, down, left and right directions, allowing the pre-assembly member 200 to be firmly secured in the U-shaped structural member 100. In another embodiment, in the process of pushing the pre-assembled nut assembly into the U-shaped structural member 100, the free end of the cantilever portion 311 of the pre-assembly member 300 is first in contact with the internal lower surface of the U-shaped structural member 100, and is then pressed, in the process of further pushing, toward the base portion 301 to generate elastic deformation. Once the cantilever portion 311 slides entirely into the hole (not shown) of the U-shaped structural member 100, the free end of the cantilever portion 311 rebounds away from the base portion, and the pre-assembled nut assembly reaches the mounting position in this case. In this mounting position, the front portion of the base portion 301 of the pre-assembly member 300 rebounds toward the lower inner surface of the U-shaped structural member 100 under the action of a deformation force, such that the lower surface of the base portion 301 completely abuts against the lower inner surface of the U-shaped structural member 100, meanwhile, the edge of the free end of the cantilever portion 311 abuts against an inner periphery of the hole (not shown) of the U-shaped structural member 100, and the groove portion 312 formed on the clamping portion 307 abuts against the inner surface of the bend portion of the U-shaped structural member 100. Similar to the previous embodiment, forces are applied to the pre-assembly member 300 in up, down, left and right directions, allowing the pre-assembly member 300 to be firmly secured in the U-shaped structural member 100. Since the nut 400 is already mounted in the pre-assembly member 200/300, the nut 400 is mounted at a predetermined position of the U-shaped structural member 100 by means of the pre-assembly member 200/300. A vehicle seat is secured to the nut 400 of the U-shaped structural member 100 by means of the bolt, and accordingly the vehicle seat is secured to the U-shaped structural member 100.

According to the present disclosure, the nut 400 is mounted in the U-shaped structural member 100 by using the pre-assembly member 200/300, and compared with a pull riveting method for mounting a nut in the prior art, this method has the advantages as follows.

First, the pull riveting method for mounting in the prior art has a higher holing precision requirement on the hole in the U-shaped structural member. If the hole is too large, the nut may be pulled out through the hole in a pull riveting process. However, in the present disclosure, by appropriately displacing the base 401 of the nut 400 in the blocking space, a tolerance of the hole is compensated, such that the nut hole 402 of the nut 400, the hole 202/302 of the pre-assembly member 200/300 and the hole in the U-shaped structural member 100 are substantially aligned to allow the subsequent insertion of the bolt; meanwhile, the requirements on the manufacturing tolerances of the components are reduced, the manufacturing efficiency is improved, and the manufacturing costs are reduced.

Second, in the prior art, the nut is mounted into the U-shaped structural member by the pull riveting method. However, in a bolt mounting process, the rotation of the bolt may cause the nut to rotate together, thus resulting in a failure of bolt mounting. Also, in the present disclosure, by providing the reinforcing ribs 210.1, 210.2 on the pre-assembly member 200 or providing the groove structure 312 on the pre-assembly member 300 and making the reinforcing ribs/the groove structure abut against the inner surface of the bend portion of the U-shaped structural member 100, the pre-assembly member 200/300 cannot rotate about the central axis of the hole of the U-shaped structural member, so that the rotation of the nut 400 driven by the rotation of the bolt is avoided in the process of mounting the bolt, and the bolt mounting is more convenient.

Third, in the prior art, a special pull riveting tool is required to mount the nut into the U-shaped structural member. However, in the present disclosure, the nut 400 can be securely mounted at the predetermined position of the U-shaped structural member 100 only by manually pushing the pre-assembled nut assembly into the U-shaped structural member 100, so that the time and effort required for mounting are saved on.

Although the present disclosure is described with respect to the examples of the embodiments outlined above, various alternatives, modifications, variations, improvements, and/or substantial equivalents that are known or current or to be anticipated later may be apparent to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

What is claimed is:

1. A pre-assembly member (200, 300) for mounting to a U-shaped structural member (100), the pre-assembly member (200, 300) comprising:
a base portion (201, 301); and
a clamping portion (207, 307), wherein the clamping portion (207, 307) is formed by bending and extending upward from a rear portion of the base portion (201, 301), and the clamping portion (207, 307) is configured to secure the pre-assembly member (200, 300) to the U-shaped structural member (100).

2. The pre-assembly member (200, 300) according to claim 1, wherein
the base portion (201, 301) comprises:
a hole (202, 302), the hole (202, 302) being formed in the base portion (201, 301);
a front bending edge (203, 303), the front bending edge (203, 303) extending upward from a front portion of the base portion (201, 301), and the front bending edge (203, 303) forming a front blocking portion;
two side bending edges (204.1, 204.2; 304.1, 304.2), the two side bending edges (204.1, 204.2; 304.1, 304.2) being provided opposite each other, the two side bending edges (204.1, 204.2; 304.1, 304.2) respectively extending upward from two side portions of the base portion (201, 301), and the two side bending edges (204.1, 204.2; 304.1, 304.2) forming two side blocking portions; and
two transverse bending edges (205.1, 205.2; 305.1, 305.2), the two transverse bending edges (205.1, 205.2; 305.1, 305.2) respectively extending from distal ends of the two side bending edges (204.1, 204.2; 304.1, 304.2), and two side mounting spaces (206.1, 206.2; 306.1, 306.2) being formed below the two side bending edges (204.1, 204.2; 304.1, 304.2).

3. The pre-assembly member (200, 300) according to claim 2, wherein
the base portion (201, 301) extends downward from a lower surface thereof to form an extension portion (211, 311), and the extension portion (211, 311) has different heights in a direction from a front portion to a rear portion of the base portion (201, 301) and is configured to clamp the pre-assembly member (200, 300) in the U-shaped structural member (100).

4. The pre-assembly member (200, 300) according to claim 3, wherein
the extension portion (211) is an inclined cut portion (211) formed by extending downward from the base portion (201) along a hole diameter of the hole (202).

5. The pre-assembly member (200, 300) according to claim 3, wherein
the extension portion (311) is a cantilever portion (311) formed by extending downward from the base portion (301) along an edge of the hole (302), the cantilever portion (311) is of an annular structure, and part of an edge of the annular structure is connected to the base portion (301).

6. The pre-assembly member (200, 300) according to claim 1, wherein
a clamping tail (208, 308) is provided at a distal end of the clamping portion (207, 307).

7. The pre-assembly member (200, 300) according to claim 6, wherein
the clamping tail (208, 308) is made of an elastic material.

8. The pre-assembly member (200, 300) according to claim 7, wherein
the clamping tail (208, 308) comprises one or more clamping tail portions (208.1, 208.2, 208.3; 308.1, 308.2).

9. The pre-assembly member (200, 300) according to claim 2, wherein
a tongue (209, 309) is provided at a proximal end of the clamping portion (207, 307), the tongue (209, 309) being arranged between the two side bending edges (204.1, 204.2; 304.1, 304.2), and a rear mounting space being formed below the tongue (209, 309).

10. The pre-assembly member (200, 300) according to claim 9, wherein
the tongue (209, 309) extends from the proximal end of the clamping portion (207, 307) toward the base portion (201, 301).

11. The pre-assembly member (200, 300) according to claim 1, wherein
reinforcing ribs (210.1, 210.2; 310.1, 310.2) are provided in a middle portion of the clamping portion (207, 307) between a distal end and a proximal end, and the reinforcing ribs (210.1, 210.2; 310.1, 310.2) protrude from the middle portion of the clamping portion (207, 307) in a direction away from or close to the base portion (201, 301).

12. The pre-assembly member (300) according to claim 2, wherein
a plurality of elastic sheet portions (301.1, 301.2, 301.3, 301.4) are provided on the base portion (301), with one end of each of the elastic sheet portions (301.1, 301.2, 301.3, 301.4) being connected to the base portion (301), and the other end thereof protruding from an upper surface of the base portion (301).

13. The pre-assembly member (200, 300) according to claim 1, wherein
the pre-assembly member (200, 300) is integrally formed.

14. The pre-assembly member (200, 300) according to claim 1, wherein
the clamping portion (207, 307) is configured to be in shape fit with the U-shaped structural member (100), such that the clamping portion (207, 307) secures the pre-assembly member (200, 300) to the U-shaped structural member (100).

15. A pre-assembled nut assembly, comprising:
the pre-assembly member (200, 300) of claim 2; and
a nut (400);
wherein the nut (400) is configured to be mounted in the base portion (201, 301) of the pre-assembly member (200, 300).

16. The pre-assembled nut assembly according to claim 15, wherein
the nut (400) comprises:
a base (401), a middle portion of the base (401) being provided with a nut hole (402), and the base (401) having a front portion, a rear portion and two side portions; and
a body (403), the body (403) extending around the nut hole (402) of the base (401) to form a cylindrical section (405), and the cylindrical section (405) being in hollow communication with the nut hole (402).

17. The pre-assembled nut assembly according to claim 16, wherein
an inner wall of the cylindrical section (405) is provided with internal threads.

18. The pre-assembled nut assembly according to claim 16, wherein
two ends of the front portion of the base (401) of the nut (400) respectively extend to form two front end corners (406.1, 406.2); and
two ends of the rear portion of the base (401) of the nut (400) respectively extend to form two rear end corners (407.1, 407.2);
wherein the two front end corners (406.1, 406.2) and the two rear end corners (407.1, 407.2) are slightly upturned.

19. The pre-assembled nut assembly according to claim 18, wherein
when the base (401) of the nut (400) is mounted in the base portion (201, 301) of the pre-assembly member (200, 300), the two front end corners (406.1, 406.2) and the two rear end corners (407.1, 407.2) protrude from the base portion (201, 301).

20. A U-shaped structural member (100) with a pre-assembled nut assembly, the U-shaped structural member comprising:
the pre-assembled nut assembly of claim 15; and
a U-shaped structural member (100);
wherein the pre-assembled nut assembly is configured to be securely mounted in the U-shaped structural member (100).
